(19) United States
(12) Patent Application Publication
(10) Pub. No.: US 2014/0085137 A1
(43) Pub. Date: Mar. 27, 2014

(54) DEVICE AND METHOD FOR PROVIDING LOCATION INFORMATION BY SMART NAVIGATION

(71) Applicant: Electronics and Telecommunications Research Institute, Daejeon (KR)

(72) Inventor: Cheon Sig SIN, Daejeon (KR)

(73) Assignee: Electronics and Telecommunications Research Institute, Daejeon (KR)

(21) Appl. No.: 14/025,246

(22) Filed: Sep. 12, 2013

(30) Foreign Application Priority Data
Sep. 27, 2012 (KR) 10-2012-0107841
May 16, 2013 (KR) 10-2013-0055818

(51) Int. Cl. G01S 5/02; G01S 19/42

(52) U.S. Cl. CPC G01S 5/0242; G01S 19/42
USPC 342/357.25; 342/385

(57) ABSTRACT

A device and method for providing location information by smart navigation are provided. The device for providing location information may include a generation unit to generate visual synchronization information in response to a location information request from a terminal, a transmission unit to transmit the visual synchronization information and to control the visual synchronization information to be transferred to the terminal, and a computation unit to extract location information of a transmitting station from the visual synchronization information received from the terminal and to compute a location of the terminal.

### CROSS-REFERENCE TO RELATED APPLICATIONS

This application claims the benefit of Korean Patent Application No. 10-2012-0107841 and of Korean Patent Application No. 10-2013-0055818, respectively filed on Sep. 27, 2012 and May 16, 2013, in the Korean Intellectual Property Office, the disclosures of which are incorporated herein by reference.

### BACKGROUND

1. Field of the Invention

The present invention relate to a technology for searching for a transmitting station that transmits a radio wave to a terminal and for generating visual synchronization information, in response to a location information request from the terminal, and for computing a location of the terminal based on the visual synchronization information.

2. Description of the Related Art

To compute a location of a terminal, most systems use navigation signals provided by a global positioning system (GPS) that is a global satellite navigation system. Through navigation signals, network synchronization between systems, and synchronization between signal processing boards within a system may be performed. However, when an error occurs in a navigation signal or the navigation signal is blocked, computation of location information may be limited. Additionally, accuracy of the location information may be reduced due to interference caused by various radio waves, because the navigation signal has an extremely low received signal strength in the ground.

Accordingly, there is a desire for a technology that may stably compute a location of a terminal through a transmitting station that transmits a radio wave, by using an existing information communication-related infrastructure, when an error occurs in the navigation signal.

### SUMMARY

An aspect of the present invention is to search for a transmitting station that transmits a radio wave to a terminal, to generate visual synchronization information between the transmitting station and the terminal, and to compute a location of the terminal.

Another aspect of the present invention is to generate a ranging signal, and to increase accuracy of the visual synchronization information.

According to an aspect of the present invention, there is provided a device for providing location information, the device including: a generation unit to generate visual synchronization information in response to a location information request from a terminal; a transmission unit to transmit the visual synchronization information, and to control the visual synchronization information to be transferred to the terminal; and a computation unit to extract location information of a transmitting station from the visual synchronization information received from the terminal, and to compute a location of the terminal According to another aspect of the present invention, there is provided a method of providing location information, the method including: searching for a transmitting station and generating visual synchronization information, in response to a location information request from a terminal, the transmitting station transmitting a radio wave to the terminal; transmitting the visual synchronization information to the found transmitting station, and controlling the visual synchronization information to be transferred from the transmitting station to the terminal through the radio wave; and extracting location information of the transmitting station from the visual synchronization information received from the terminal, and computing a location of the terminal

### EFFECT

According to embodiments of the present invention, it is possible to generate visual synchronization information using a ground infrastructure, such as broadcasting, communication, and the like, that is conventionally installed and operated, and is possible to compute a location of a terminal.

Additionally, according embodiments of the present invention, it is possible to back up visual synchronization information and location information, upon occurrence of jamming of navigation signals provided by a global positioning system (GPS) navigation satellite.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating a configuration of a location information providing device according to an embodiment of the present invention;

FIG. 2 is a block diagram illustrating, in detail, a configuration of a location information providing device according to an embodiment of the present invention;

FIG. 3 is a diagram illustrating computation of a location of a terminal according to an embodiment of the present invention; and

FIG. 4 is a flowchart illustrating a method of providing location information according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

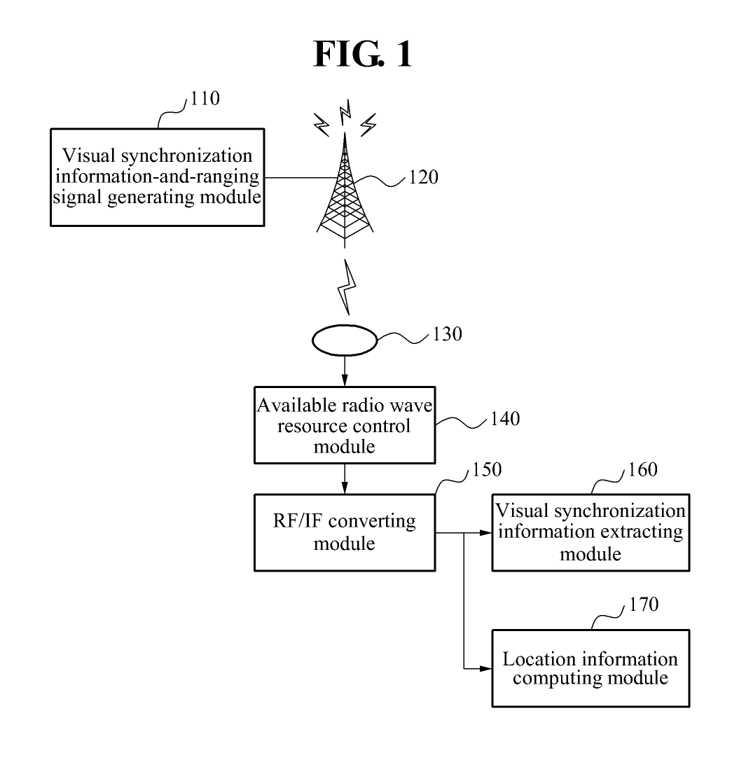

FIG. 1 is a diagram illustrating a configuration of a location information providing device according to an embodiment of the present invention.

Referring to FIG. 1, the location information providing device may compute a location of a terminal, using an infrastructure that is installed in advance. The infrastructure may refer to hardware or facilities used to transmit and receive radio waves and to provide a communication infrastructure of a terminal The infrastructure may transfer information between terminals, through a signal transmitted from a transmitting station 120.

When jamming of navigation signals of a global positioning system (GPS) satellite occurs in a GPS-based location information system, the location information providing device may perform backup through a radio wave of the infrastructure, and may compute a location of a terminal.

The location information providing device may include a visual synchronization information-and-ranging signal generating module 110, an available radio wave resource control module 140, a radio frequency (RF)/intermediate frequency (IF) converting module 150, a visual synchronization information extracting module 160, and a location information computing module 170.

The visual synchronization information-and-ranging signal generating module 110 may generate a ranging signal and visual synchronization information that may be required to compute a location of a terminal The visual synchronization information may be associated with a time in which a signal is transmitted between the transmitting station 120 and the terminal. The location information providing device may calculate a distance between the transmitting station 120 and the terminal, based on the visual synchronization information, and may compute the location of the terminal based on the calculated distance. The visual synchronization information may include a time in which a signal is transmitted, and a time in which the signal is received. The visual synchronization information-and-ranging signal generating module 110 may be connected to equipment of the transmitting station 120, and may transmit the visual synchronization information to the transmitting station 120. The transmitting station 120 may transfer the visual synchronization information to the terminal through the radio wave. The visual synchronization information-and-ranging signal generating module 110 may generate a ranging signal used to synchronize timing that may be used as a criterion in various terminals and the transmitting station 120. The visual synchronization information-and-ranging signal generating module 110 may control a time in which the visual synchronization information is transmitted, using the ranging signal. The visual synchronization information may be included in the ranging signal.

The transmitting station 120 may transfer the visual synchronization information to the terminal, through the radio wave. The transmitting station 120 may include at least one of a broadcast-based transmitting station, a radio-based transmitting station, and a mobile communication base station. The broadcast-based transmitting station may transmit radio waves of a very high frequency (VHF) band and ultra high frequency (UHF) band, and the radio-based transmitting station may transmit radio waves of a frequency modulation (FM) band and amplitude modulation (AM) band. The mobile communication base station may transmit radio waves of a frequency band between 800 megahertz (MHz) and 2.1 gigahertz (GHz). The location information providing device may select the transmitting station 120 variably depending on whether a radio wave is available, and may control the visual synchronization information to be stably transferred.

The terminal may include an adaptive antenna 130 used to receive the visual synchronization information. The adaptive antenna 130 may receive radio waves of the VHF band, UHF band, FM band, AM band, and the frequency band between 800 MHz and 2.1 GHz that may exist within a predetermined range.

When the terminal receives a radio wave via the adaptive antenna 130, the available radio wave resource control module 140 may select the radio wave, and may determine the radio wave to be an available radio wave resource. The available radio wave resource control module 140 may select a radio wave that may be used to accurately transfer visual synchronization information. For example, the available radio wave resource control module 140 may determine, to be the available radio wave resource, a radio wave transmitted from the transmitting station 120 located near the terminal.

The RF/IF converting module 150 may perform signal processing on the available radio wave resource, and may convert a frequency band. To transmit visual synchronization information without interference, the transmitting station 120 may convert a frequency band of a radio wave to an RF band, and may transfer the visual synchronization information to the terminal. When the radio wave is determined to be an available radio wave resource, the RF/IF converting module 150 may convert the frequency band of the radio wave to an IF band, to extract the visual synchronization information. The RF/IF converting module 150 may extract an IF band corresponding to a difference between the RF band and a set frequency band.

The visual synchronization information extracting module 160 may extract visual synchronization information, when a frequency band of the available radio wave resource is converted. The location information computing module 170 may acquire location information of the transmitting station 120 from the visual synchronization information. Additionally, the location information computing module 170 may calculate a distance between the terminal and the transmitting station 120, based on the visual synchronization information. The location information computing module 170 may calculate a distance between the terminal and each of at least four transmitting stations, and may compute a location of the terminal using a triangulation.

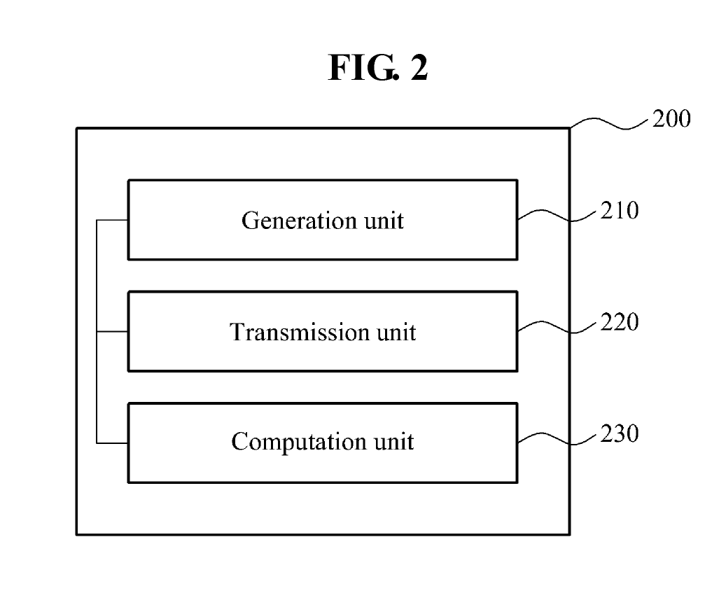

FIG. 2 is a block diagram illustrating, in detail, a configuration of a location information providing device 200 according to an embodiment of the present invention.

The location information providing device 200 may include a generation unit 210, a transmission unit 220, and a computation unit 230.

The generation unit 210 may search for a transmitting station that transmits a radio wave to a terminal, in response to a location information request from the terminal. The terminal may access a telephone and the Internet through the transmitting station, and may receive a TV signal and a radio signal. The transmitting station may transmit, to a specific terminal or a plurality of unspecified terminals, radio waves of a VHF band, a UHF band, an FM band, an AM band, and a frequency band between 800 MHz to 2.1 GHz. The generation unit 210 may search for the transmitting station, based on information included in a radio wave received via an antenna of the terminal.

The generation unit 210 may search for a transmitting station that transmits a radio wave with a relatively high intensity, from among transmitting stations. Additionally, the generation unit 210 may search for a transmitting station that is located near the terminal.

The generation unit 210 may be connected to the transmitting station and may generate visual synchronization information. The visual synchronization information may be associated with a time in which a signal is transferred between the transmitting station and the terminal, and may notify a time required from a reference point in time to a point in time in which the signal is transmitted. The visual synchronization information may be used to calculate a distance between the terminal and the transmitting station. The generation unit 210 may generate the visual synchronization information, based on a time in which the signal is transmitted and a time in which the signal is received. Additionally, the generation unit 210 may include location information of the transmitting station in the visual synchronization information.

When jamming is not detected in a GPS signal received from the terminal, the generation unit 210 may generate visual synchronization information between the terminal and a GPS satellite that transmits the GPS signal.

The transmission unit 220 may transmit the visual synchronization information through a radio wave of the transmitting station.

The transmission unit 220 may transmit the visual synchronization information so that the visual synchronization information may be transferred to the terminal through a radio wave, in which jamming does not occur, among radio waves that may be available by the transmitting station.

The transmission unit 220 may transmit the visual synchronization information, through a ranging signal that may be generated simultaneously in the transmitting station and the terminal The ranging signal may refer to an accurate timing signal between the transmitting station and the terminal, and may include information regarding all clocks used in the transmitting station. The transmission unit 220 may synchronize a transmission speed of the visual synchronization information, through the ranging signal. The visual synchronization information may be included in the ranging signal.

When a radio wave is not received from the transmitting station to the terminal within a selected intensity range, the generation unit 210 may re-search for a transmitting station that may transmit an available radio wave to the terminal.

The transmission unit 220 may transfer the visual synchronization information to the found transmitting station, and may control the visual synchronization information to be transmitted from the transmitting station to the terminal through the radio wave.

The computation unit 230 may extract location information of the transmitting station from the visual synchronization information received from the terminal, and may compute a location of the terminal.

The computation unit 230 may select “n” transmitting stations from among transmitting stations that transfer the visual synchronization information to the terminal, and may calculate a distance from the terminal to each of the “n” transmitting stations. In this instance, “n” may be a natural number equal to or greater than “4.” A time difference between the terminal and the transmitting station may be obtained based on the ranging signal.

The computation unit 230 may measure a time in which the visual synchronization information is transferred from each of the “n” transmitting stations to the terminal, and may calculate the distance. To obtain the distance, the computation unit 230 may multiply the time in which the visual synchronization information is transferred by a speed of the radio wave.

The computation unit 230 may compute the location of the terminal, using a triangulation that is based on the location of the terminal and the transmitting station. The triangulation may be used to compute the location of the terminal from the distance and the location of the transmitting station, through an equation defined with properties of an angle and a length of a triangle.

When an adaptive antenna used to identify the visual synchronization information is not included in the terminal, the computation unit 230 may receive a radio wave from the transmitting station via the terminal, and may identify the visual synchronization information.

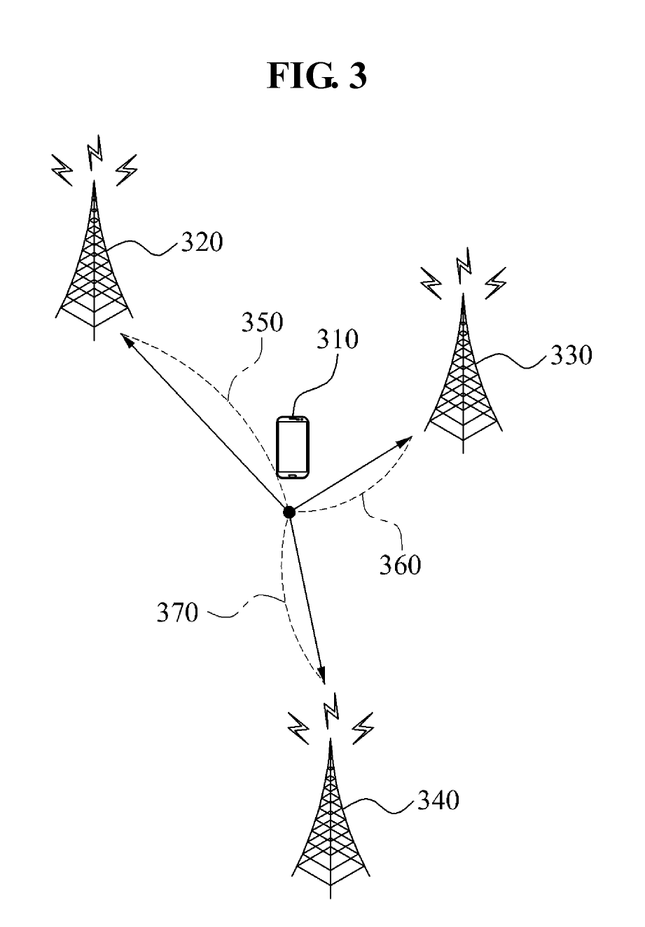

FIG. 3 is a diagram illustrating computation of a location of a terminal according to an embodiment of the present invention.

Referring to FIG. 3, in response to a location information request from a terminal 310, a location information providing device may search for a transmitting station that may transmit a radio wave to the terminal 310.

When jamming is detected in a GPS signal received from the terminal 310, the location information providing device may search for the transmitting station.

The location information providing device may search for the transmitting station, based on information included in a radio wave received via an antenna of the terminal 310. The location information providing device may search for, as a transmitting station, a broadcast transmitting station 320, a radio transmitting station 330, and a mobile communication base station 340. The broadcast transmitting station 320 may transmit a broadcast signal of a VHF band and UHF band, and the radio transmitting station 330 may transmit a radio signal of an FM band and AM band. The mobile communication base station 340 may transmit a wireless Internet signal of a frequency band between 800 MHz and 2.1 GHz. The location information providing device may search for a transmitting station that may be located near the terminal and that may transmit a radio wave with a relatively high intensity.

The location information providing device may be connected to the broadcast transmitting station 320, the radio transmitting station 330 and the mobile communication base station 340, and may generate visual synchronization information. The visual synchronization information may be associated with a time in which a signal is transferred between the transmitting station and the terminal, and may indicate a time required from a reference point in time to a point in time in which the signal is transmitted. The location information providing device may generate visual synchronization information, based on a time in which the signal is transmitted, a time in which the signal is received, and the location of the transmitting station.

The location information providing device may transmit the visual synchronization information, through a radio wave of the transmitting station. The location information providing device may transmit the visual synchronization information so that the visual synchronization information may be transferred to the terminal 310 through a radio wave, in which jamming does not occur, among radio waves that may be available by the transmitting station.

The location information providing device may transmit the visual synchronization information, through a ranging signal that may be generated simultaneously in the transmitting station and the terminal 310. The ranging signal may refer to an accurate timing signal between the transmitting station and the terminal 310, and may include information regarding all clocks used in the transmitting station. The location information providing device may synchronize a transmission speed of the visual synchronization information, using the ranging signal. The ranging signal may be used to synchronize timing used as a criterion in the transmitting station and the terminal 310, and to prevent the transmitting station and the terminal 310 from interfering and colliding with each other. The visual synchronization information may be included in the ranging signal.

When a radio wave is not received from the transmitting station to the terminal 310 within a selected intensity range, the location information providing device may re-search for a transmitting station that may transmit an available radio wave to the terminal The location information providing device may replace a current radio wave by a radio wave transmitted from a transmitting station that is located near the terminal 310, and may accurately transfer the visual synchronization information.

The location information providing device may transmit the visual synchronization information to the broadcast transmitting station 320, the radio transmitting station 330 and the mobile communication base station 340, and may control the visual synchronization information to be transferred to the terminal 310 through a radio wave.

The location information providing device may extract location information of a transmitting station from the visual synchronization information received from the terminal 310. When the location information is extracted, the location information providing device may measure a time in which visual synchronization information is transferred from each transmitting station to the terminal 310. The location information providing device may multiply the measured time by a speed of the radio wave, and may obtain a distance 350 between the terminal 310 and the broadcast transmitting station 320, a distance 360 between the terminal 310 and the radio transmitting station 330, and a distance 370 between the terminal 310 and the mobile communication base station 340.

To increase accuracy of location information, the location information providing device may further search for a transmitting station, may obtain a distance between the terminal 310 and the found transmitting station, and may calculate location information of the four transmitting stations.

The location information providing device may compute a location of a terminal, using a triangulation that is based on the location of the terminal and the transmitting station. The location information providing device may substitute a distance between the transmitting station and the terminal in an equation defined with properties of an angle and a length of a triangle, and may compute the location of the terminal

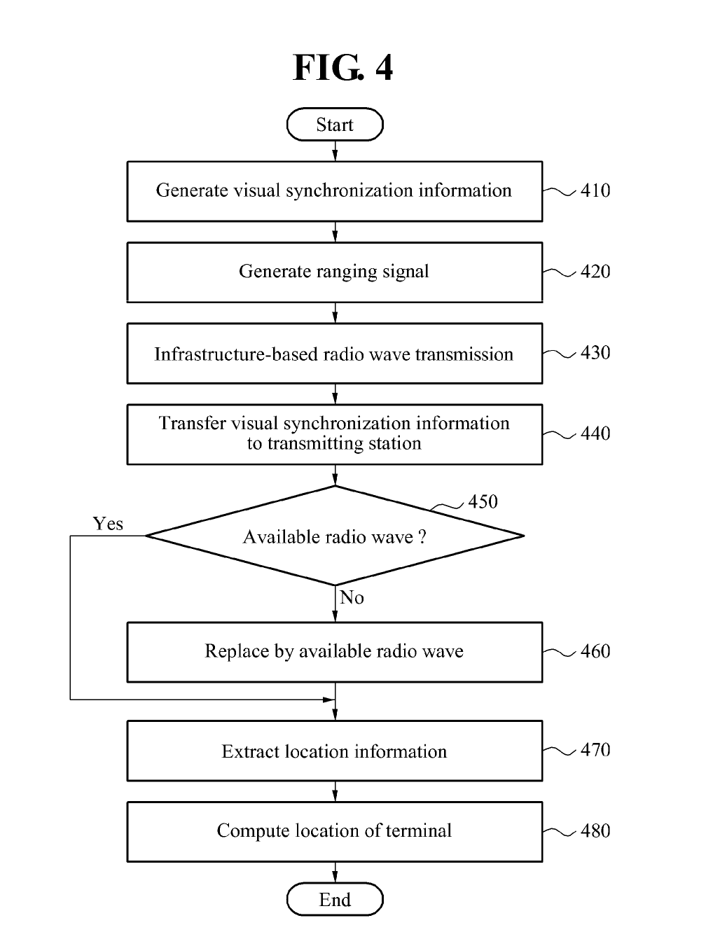

FIG. 4 is a flowchart illustrating a method of providing location information according to an embodiment of the present invention.

Referring to FIG. 4, in operation 410, a location information providing device may search for a transmitting station that transmits a radio wave to a terminal, and may generate visual synchronization information, in response to a location information request from the terminal. The terminal may access a telephone and Internet through the transmitting station, and may receive a TV signal and a radio signal. The transmitting station may transmit, to a specific terminal or a plurality of unspecified terminals, radio waves of a VHF band, a UHF band, an FM band, an AM band, and a frequency band between 800 MHz to 2.1 GHz. The location information providing device may search for the transmitting station, based on information included in a radio wave received via an antenna of the terminal. The location information providing device may search for a transmitting station that transmits a radio wave with a relatively high intensity, from among transmitting stations. For example, the location information providing device may search for a transmitting station that is located near the terminal The location information providing device may be connected to the transmitting station, and may generate visual synchronization information. The visual synchronization information may be associated with a time in which a signal is transferred between the transmitting station and the terminal, and may notify a time required from a reference point in time to a point in time in which the signal is transmitted. The visual synchronization information may be used to calculate a distance between the terminal and the transmitting station. The location information providing device may generate the visual synchronization information, based on a time in which the signal is transmitted and a time in which the signal is received. Additionally, the location information providing device may include location information of the transmitting station in the visual synchronization information. When jamming is not detected in a GPS signal received from the terminal, the location information providing device may generate visual synchronization information between the terminal and a GPS satellite that transmits the GPS signal.

In operation 420, the location information providing device may generate a ranging signal, to increase accuracy of the visual synchronization information. The ranging signal may refer to an accurate timing signal between the transmitting station and the terminal, and may include information regarding all clocks used in the transmitting station. The location information providing device may synchronize a transmission speed of the visual synchronization information, through the ranging signal. The ranging signal may be used to synchronize timing used as a criterion in the transmitting station and the terminal, and to prevent the transmitting station and the terminal from interfering and colliding with each other. The visual synchronization information may be included in the ranging signal.

In operation 430, the location information providing device may realize infrastructure-based radio wave transmission, by transmitting the visual synchronization information through a radio wave of the transmitting station. The location information providing device may transfer the visual synchronization information to the found transmitting station in operation 440, and may control the visual synchronization information to be transmitted from the transmitting station to the terminal through the radio wave.

In operation 450, the location information providing device may determine whether the radio wave transmitted from the transmitting station is available. When an intensity of the radio wave is beyond a selected intensity range, the radio wave may be determined to be available. When the intensity of the radio wave is within the selected intensity range, the location information providing device may re-search for a transmitting station that transmits an available radio wave, and may replace the radio wave by the available radio wave in operation 460. The location information providing device may transmit the visual synchronization information so that the visual synchronization information may be transferred to the terminal through a radio wave, in which jamming does not occur, among radio waves that are available by the transmitting station. The location information providing device may transmit the visual synchronization information through a ranging signal that may be generated simultaneously in the terminal and the transmitting station.

In operation 470, the location information providing device may extract location information of the transmitting station from the visual synchronization information received from the terminal In operation 480, the location information providing device may compute a location of the terminal using the location information.

The location information providing device may select “n” transmitting stations from among transmitting stations that transfer the visual synchronization information to the terminal, and may calculate a distance from the terminal to each of the “n” transmitting stations. In this instance, “n” may be a natural number equal to or greater than “4.” The location information providing may measure a time in which the visual synchronization information is transferred from each of the “n” transmitting stations to the terminal, and may calculate the distance. To calculate the distance, the location information providing device may multiply the time in which the visual synchronization information is transferred by a speed of the radio wave.

The location information providing device may compute the location of the terminal, using a triangulation that is based on the location of the terminal and the transmitting station. The triangulation may be used to compute the location of the terminal from the distance and the location of the transmitting station, through an equation defined with properties of an angle and a length of a triangle.

When an adaptive antenna used to identify the visual synchronization information is not included in the terminal, the location information providing device may receive a radio wave from the transmitting station via the terminal, and may identify the visual synchronization information.

The above-described embodiments of the present invention may be recorded in non-transitory computer-readable media including program instructions to implement various operations embodied by a computer. The media may also include, alone or in combination with the program instructions, data files, data structures, and the like. The program instructions recorded on the media may be those specially designed and constructed for the purposes of the embodiments, or they may be of the kind well-known and available to those having skill in the computer software arts. Examples of non-transitory computer-readable media include magnetic media such as hard disks, floppy disks, and magnetic tape; optical media such as CD ROM disks and DVDs; magneto-optical media such as optical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention, or vice versa.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A device for providing location information by smart navigation, the device comprising:
a generation unit to search for a transmitting station, and to generate visual synchronization information, in response to a location information request from a terminal, the transmitting station transmitting a radio wave to the terminal;
a transmission unit to transmit the visual synchronization information to the found transmitting station, and to control the visual synchronization information to be transferred from the transmitting station to the terminal through the radio wave; and
a computation unit to extract location information of the transmitting station from the visual synchronization information received from the terminal, and to compute a location of the terminal.

2. The device of claim 1, wherein the generation unit searches for a transmitting station that transmits a radio wave with a relatively high intensity, from among transmitting stations that at least comprise a transmitting station that transmits a broadcast-related radio wave, a transmitting station that transmits a radio-related radio wave, and a transmitting station that transmits an Internet-related radio wave.

3. The device of claim 1, wherein, when jamming is not detected in a global positioning system (GPS) signal received from the terminal, the generation unit generates visual synchronization information between the terminal and a GPS satellite that transmits the GPS signal.

4. The device of claim 1, wherein the transmission unit transmits the visual synchronization information so that the visual synchronization information is transferred to the terminal through a radio wave, in which jamming does not occur, among radio waves that are available by the transmitting station.

5. The device of claim 1, wherein the transmission unit transmits the visual synchronization information to the found transmitting station, through a ranging signal generated simultaneously in the transmitting station and the terminal.

6. The device of claim 1, wherein, when a radio wave is not received from the transmitting station to the terminal within a selected intensity range, the generation unit re-searches for a transmitting station that transmits an available radio wave to the terminal.

7. The device of claim 1, wherein the computation unit selects “n” transmitting stations from among transmitting stations that transfer the visual synchronization information to the terminal, and calculates a distance between the terminal and each of the “n” transmitting stations, wherein “n” is a natural number equal to or greater than “4.”

8. The device of claim 7, wherein the computation unit measures a time in which the visual synchronization information is transferred from each of the “n” transmitting stations to the terminal, and calculates the distance.

9. The device of claim 1, wherein the computation unit computes the location of the terminal from a distance between the terminal and the transmitting station, using a triangulation based on the location of the terminal and the transmitting station.

10. The device of claim 1, wherein, when an adaptive antenna used to identify the visual synchronization information is not included in the terminal, the computation unit receives a radio wave from the transmitting station via the terminal, and identifies the visual synchronization information.

11. A method of providing location information by smart navigation, the method comprising:
searching for a transmitting station, and generating visual synchronization information, in response to a location information request from a terminal, the transmitting station transmitting a radio wave to the terminal;
transmitting the visual synchronization information to the found transmitting station, and controlling the visual synchronization information to be transferred from the transmitting station to the terminal through the radio wave; and
extracting location information of the transmitting station from the visual synchronization information received from the terminal, and computing a location of the terminal.

12. The method of claim 11, wherein the searching comprises searching for a transmitting station that transmits a radio wave with a relatively high intensity, from among transmitting stations that at least comprise a transmitting station that transmits a broadcast-related radio wave, a transmitting station that transmits a radio-related radio wave, and a transmitting station that transmits an Internet-related radio wave.

13. The method of claim 11, wherein the searching comprises, when jamming is not detected in a global positioning system (GPS) signal received from the terminal, generating visual synchronization information between the terminal and a GPS satellite that transmits the GPS signal.

14. The method of claim 11, wherein the transmitting comprises transmitting the visual synchronization information so that the visual synchronization information is transferred to the terminal through a radio wave, in which jamming does not occur, among radio waves that are available by the transmitting station.

15. The method of claim 11, wherein the transmitting comprises transmitting the visual synchronization information to the found transmitting station, through a ranging signal generated simultaneously in the transmitting station and the terminal.

16. The method of claim 11, further comprising:
re-searching for a transmitting station that transmits an available radio wave to the terminal, when a radio wave is not received from the transmitting station to the terminal within a selected intensity range.

17. The method of claim 11, further comprising:
selecting “n” transmitting stations from among transmitting stations that transfer the visual synchronization information to the terminal, and calculating a distance between the terminal and each of the “n” transmitting stations, wherein “n” is a natural number equal to or greater than “4.”

18. The method of claim 17, wherein the selecting comprises measuring a time in which the visual synchronization information is transferred from each of the “n” transmitting stations to the terminal, and calculating the distance.

19. The method of claim 11, wherein the extracting comprises computing the location of the terminal from a distance between the terminal and the transmitting station, using a triangulation based on the location of the terminal and the transmitting station.

20. The method of claim 11, further comprising:
receiving a radio wave from the transmitting station via the terminal, and identifying the visual synchronization information, when an adaptive antenna used to identify the visual synchronization information is not included in the terminal.
